(19) United States
(12) Patent Application Publication
(10) Pub. No.: US 2005/0200754 A1
(43) Pub. Date: Sep. 15, 2005

(54) Image photographing apparatus

(75) Inventor: Chang-hee Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/052,292

(22) Filed: Feb. 8, 2005

(30) Foreign Application Priority Data
Mar. 10, 2004 (KR) 10-2004-0016193

(51) Int. Cl. H04N 5/225; H04N 5/222

(52) U.S. Cl. 348/376; 348/371

(57) ABSTRACT

An image photographing apparatus has a first image photographing device unit and a second image photographing device unit. The image photographing apparatus also has a function of a camcorder provided by the first image photographing device unit, and a function of a digital camera provided by the second image photographing device unit, and wherein a portion of the first and second image photographing device units is protruded at a front of the main body of the apparatus. A fixed or popup flash can be further provided and is mounted to an upper side or a flank side of the main body to avoid the shading of the light by the first image photographing device unit.

### CROSS-REFERENCE TO RELATED APPLICATIONS

This application claims the benefit under 35 U.S.C. §119(a) of Korean Patent Application No. 10-2004-0016193 filed in the Korean Intellectual Property Office on Mar. 10, 2004, the entire contents of which are incorporated herein by reference.

### BACKGROUND OF THE INVENTION

1. Field of the Invention

The present invention relates to an image photographing apparatus which is capable of photographing an image. More particularly, the present invention relates to an image photographing apparatus which is capable of photographing an image including a moving image and a still image, storing and reproducing a photographed image, and which has a flash at a certain position.

2. Description of the Related Art

Generally, a digital camera converts an image projected through a lens into a digital signal to store in a recording media, such as a hard disk or a memory card. The digital camera is further highly compatible with a personal computer PC to conveniently allow edits and amendments to the image. Such digital cameras are primarily used for photographing a still image mainly due to the capacity limits of an image recording media used. The digital camera also has a function of photographing a moving image, however, it is difficult to photograph a moving image for a long period. To overcome these drawbacks of the digital camera, a recording and/or reproducing apparatus such as a camcorder, which is capable of recording and reproducing an image and sound of a subject to a recording media such as a tape, is more widely popularized for this use.

The camcorder usually applies a magnetic tape for a recording media, and has the magnetic tape in a deck device to record a photographed moving image. The camcorder can easily photograph a moving image for greater periods, such as periods of more than one hour. Such camcorders may also have a function of photographing a still image, however, an image quality is less than that provided by the aforementioned digital camera, and therefore, the camcorder is mainly used for photographing a moving image.

Currently, in order to use each function of the digital camera and camcorder, both products had to be purchased. Accordingly, a consumer is burdened with the additional costs. Furthermore, it is inconvenient because a user is then required to carry both of the products.

Accordingly, a need exists for a multifunction photographing device such that a user can selectively use a function of a digital camera and a function of a camcorder.

### SUMMARY OF THE INVENTION

The present invention has been provided to solve the above-mentioned and other problems occurring in the prior art, and an aspect of the present invention is to provide a developed image photographing apparatus having functions of both a digital camera and a camcorder.

In order to achieve the above aspects, an image photographing apparatus is provided comprising a main body forming an external appearance of the image photographing apparatus and having a recording media, a first image photographing device unit mounted to the main body and capable of photographing a moving image, a second image photographing device unit mounted to the main body and capable of photographing a still image or a moving image, and a flash for photographing a still image. The flash can be mounted to a front part of an upper side of the main body to avoid shading of the light by the first image photographing device unit or the second image photographing device unit.

The first image photographing device unit may comprise a first image photographing device lens part protrusively configured at a front side of the main body to receive the image. The second image photographing device unit may comprise a second image photographing device lens part protrusively configured at a front side of the main body and vertically parallel with the first image photographing device lens part to receive the image.

The image photographing apparatus may further comprise a flash mounted to a side of the main body to avoid shading of the light by the first image photographing device unit. The flash may further comprise a popping up function.

According to another embodiment of the present invention, an image photographing apparatus is provided and comprises a main body forming an external appearance and having a recording media for recording and reproducing an image, a first image photographing device unit mounted to the main body and capable of photographing a moving image, a second image photographing device unit mounted to the main body and capable of photographing a still image or a moving image, and a flash for photographing a still image. The flash can be mounted to a flank side of the main body to avoid shading of the light by the first image photographing device unit or the second image photographing device unit. The flash may further comprise a popping up function.

### BRIEF DESCRIPTION OF THE DRAWINGS

The above and other aspects, features and advantages of the present invention will become more apparent from the following detailed description taken with reference to the accompanying drawings, in which:

FIG. 1 is a perspective view of an image photographing apparatus having a fixed flash unit according to an embodiment of the present invention;

FIG. 2 is a perspective view of an image photographing apparatus having a popup flash unit on an upper side of the main body according to an embodiment of the present invention; and

FIG. 3 is a perspective view of an image photographing apparatus having a popup flash unit at a flank side of the main body according to an embodiment of the present invention.

Throughout the drawings, like reference numerals will be understood to refer to like parts, components and structures.

### DETAILED DESCRIPTION OF THE EXEMPLARY EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and element descriptions, are provided to assist in a comprehensive understanding of the invention. Also, well-known functions or constructions are not described in detail since they would obscure the invention in unnecessary detail.

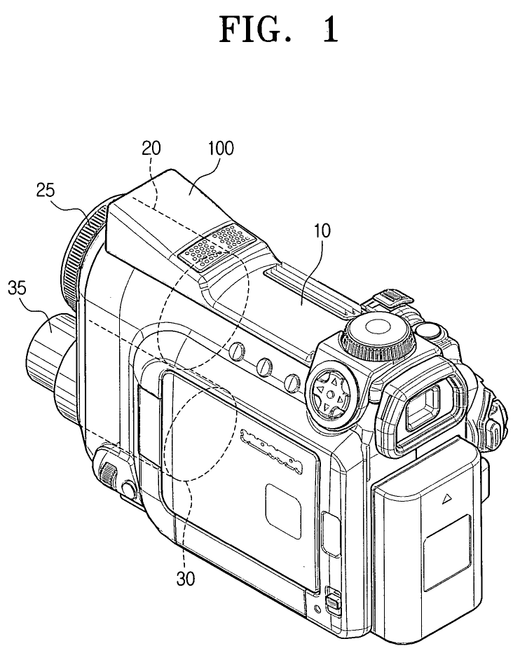

Referring to FIG. 1, an image photographing apparatus according to an embodiment of the present invention comprises a main body 10, a first image photographing unit 20, a first image photographing device lens part 25, a second image photographing device unit 30, a second image photographing device lens part 35 and a fixed flash 100.

The main body 10 forms an external appearance of an image photographing apparatus and has a storage media (not shown) therein to reproduce or record an image. The main body 10 is usually substantially made of a plastic or metal material.

The first image photographing device unit 20 operates primarily for photographing a moving image. A camcorder may comprise the first image photographing device unit 20. A portion of the first image photographing device unit 20 is protruded at a front of the main body 10, while the rest of the first image photographing device unit 20 is disposed substantially within the main body 10. The first image photographing device unit 20 may further be configured and disposed at an upper part of the front of the main body 10 as shown in FIG. 1.

The first image photographing device lens part 25 operates to photograph a moving image and is configured and disposed at a front part of the first image photographing device unit 20 and protrudes from an external side of the main body 10.

The second image photographing device unit 30 is mounted to the main body 10 and is primarily operated to photograph a still image. A digital camera may comprise the second image photographing device unit 30. A portion of the second image photographing device unit 30 also protrudes from an external side of the main body 10, while the remainder of the image photographing device unit 30 is disposed substantially within the main body 10. The second image photographing device unit 30 is configured and disposed at a lower part of the front side of the main body 10.

The second image photographing device lens part 35 is configured and disposed at a front part of the second image photographing device unit 30 and at an external part of the main body 10.

The fixed flash 100 is configured and disposed at an upper side of the main body 10. Since the fixed flash 100 is used when a still image is photographed using the second image photographing device unit 30, the fixed flash 100 may be configured and disposed at a front part of an upper side of the main body 10, in view of proper angles between the second image photographing device unit 30 and a subject.

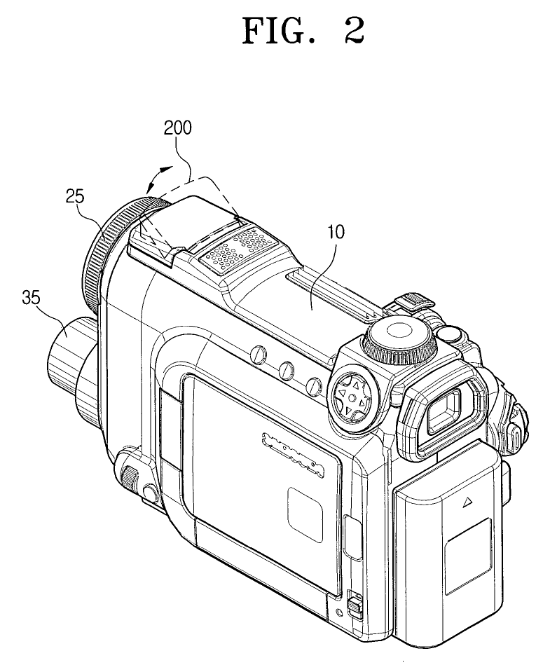

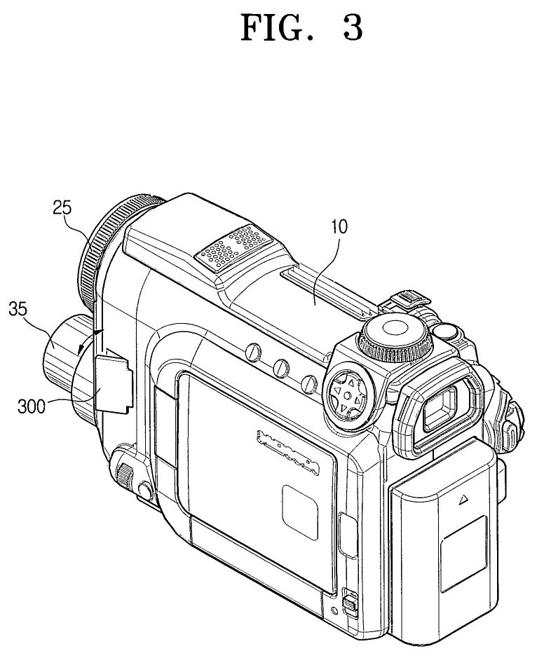

An image photographing apparatus shown in FIG. 2 according to another embodiment of the present invention comprises a popup flash 200 instead of the fixed flash 100 of FIG. 1. The popup flash 200 may be configured and disposed at substantially the same position as the fixed flash 100 to avoid shade by the first image photographing device unit 20. Specifically, the light of the popup flash 200 that is provided when the popup flash is popped up, may be emitted at substantially the same angles as that of the fixed flash 100. Since the construction and operation of the popup flash 200 in FIG. 2 and the popup flash 300 in FIG. 3, which will be described in greater detail below, are well-known, a detailed description thereof will be omitted for conciseness.

Referring to FIG. 3, a popup flash 300 is configured and disposed at a flank side of the main body 10. In yet another embodiment of the present invention, the popup flash 300 may be replaced with a fixed flash.

Hereinafter, the operation of an image photographing apparatus according to an embodiment of the present invention will be described.

The first image photographing device unit 20 comprises a first image photographing device lens part 25, a signal conversion device (not shown), and a deck device (not shown), for recording and reproducing the photographed image. An image photographed by the first image photographing device lens part 25 of the second image photographing device unit 20 is converted into magnetic data at the signal conversion device (not shown), and the magnetic data is stored through the deck device (not shown) in a magnetic tape (not shown). The data stored in the magnetic tape is reproduced through the deck device (not shown). Since the construction and operation principles of the first image photographing device unit 20 are well-known, a detailed description thereof will be omitted for conciseness.

The second image photographing device unit 30 comprises the second image photographing device lens part 35, a memory device (not shown), and a signal conversion device (not shown). A still image photographed by the second image photographing device lens part 35 is converted at the signal conversion device (not shown), into a digital signal and the digital signal is stored in the memory device (not shown), such as a hard disc (not shown) or a flash memory (not shown). Since the construction and operation principles of the second image photographing device unit 30 are well-known, the detailed description thereof will be omitted for conciseness.

An image photographing apparatus according to an embodiment of the present invention has functions of both a digital camera and a camcorder, and therefore, a user can select a camcorder function to photograph a moving image. Furthermore, a user can select a digital camera function to photograph a still image when the user wishes to obtain a higher quality photograph of a still image. Additionally, a user can purchase a single product having functions of both a camcorder and a digital camera such that the required costs are reduced.

An image photographing apparatus according to an embodiment of the present invention has each of the first image photographing device unit 20 and the second image photographing device unit 30 configured and disposed in a parallel manner with respect to a front of the main body 10, such that a user can selectively use a camcorder and a digital camera simply by pushing a selection button (not shown), and does not need to change the pose of the hand supporting the device.

If the second image photographing device unit 30 is mounted to a lower part of a front side of the main body 10, it can be important to match the angles of a subject and the angles of the flash, that is flashes 100, 200, and 300. Particularly, the first image photographing device lens part 25 protrudes at an upper part of a front side of the main body 10 such that the light emitted from the flash could be shaded. Accordingly, for the flashes 100, 200, and 300 to fully function as desired, the fixed flash 100 is mounted to an upper part of the main body 10 in view of a protrusion length of the main body 10 to avoid the shading of the light by the first image photographing device lens part 25.

An image photographing apparatus according to yet another embodiment of the present invention has the popup flash 200 instead of the fixed flash 100 as shown in FIG. 2. The popup flash 200 is mounted to a front part of an upper side of the main body 10 in substantially the same position as the fixed flash 100, to avoid the shading of the light by the first image photographing device lens part 25 when the popup flash 200 pops up.

An image photographing apparatus according to yet another embodiment of the present invention has the popup flash 300 disposed on a certain area of flank side the main body as shown in FIG. 3. The popup flash 300 is mounted to a flank side of the main body 10 to prevent the shading of the light by the first image photographing device unit 20. In yet another embodiment of the present invention, the popup flash 300 may be replaced with a fixed flash.

As described above, an image photographing apparatus according to an embodiment of the present invention has both the first image photographing device unit and the second image photographing device unit on a front side of a main body such that a user can selectively use the functions of a digital camera and a camcorder without having to change a pose. Furthermore, a flash is mounted to a front part of an upper side of the image photographing apparatus main body such that the shading of the light by the first image photographing device can be minimized. A flash can also be mounted to a flank side of a main body such that the shading of the light by the first image photographing device can be avoided.

While the present invention has been particularly shown and described with reference to exemplary embodiments thereof, it will be understood by those skilled in the art that various changes in form and details may be made therein without departing from the spirit and scope of the invention as defined by the appended claims.

1. An image photographing apparatus comprising:
a main body forming an external appearance of the image photographing apparatus and having a recording media for recording and reproducing an image;
a first image photographing device unit mounted to the main body for photographing a moving image;
a second image photographing device unit mounted to the main body for photographing a still image or a moving image; and
a flash for providing a light.

2. The image photographing apparatus according to claim 1, wherein the flash is mounted to a front part of an upper side of the main body to avoid shading of the light by the first image photographing device unit or the second image photographing device unit.

3. The image photographing apparatus according to claim 1, wherein the first image photographing device unit comprises:
a first image photographing device lens part protrusively configured and disposed at a front side of the main body to receive the moving image.

4. The image photographing apparatus according to claim 3, wherein the second image photographing device unit comprises:
a second image photographing device lens part protrusively configured and disposed at a front side of the main body and vertically parallel with the first image photographing device lens part to receive the still or moving image.

5. The image photographing apparatus according to claim 1, wherein the flash comprises a pop up function.

6. The image photographing apparatus according to claim 1, wherein the flash is mounted to a side of the main body to avoid shading of the light by the first image photographing device unit.

7. An image photographing apparatus comprising
a main body forming an external appearance and having a recording media for recording and reproducing an image;
a first image photographing device unit mounted to the main body for photographing a moving image;
a second image photographing device unit mounted to the main body for photographing a still image or a moving image; and
a flash for providing a light, mounted to a front of a flank side of the main body to avoid shading of the light by the first image photographing device unit or the second image photographing device unit.

8. The image photographing apparatus according to claim 7, wherein the flash comprises a pop up function.
